(19) United States
(12) Patent Application Publication
(10) Pub. No.: US 2021/0385348 A1
(43) Pub. Date: Dec. 9, 2021

(54) IMAGE PROCESSING APPARATUS, CONTROL METHOD, AND NON-TRANSITORY RECORDING MEDIUM

(71) Applicant: TOSHIBA TEC KABUSHIKI KAISHA, Tokyo (JP)

(72) Inventor: Hiroyuki KATO, Mishima Shizuoka (JP)

(73) Assignee: TOSHIBA TEC KABUSHIKI KAISHA, Tokyo (JP)

(21) Appl. No.: 17/406,841

(22) Filed: Aug. 19, 2021

Related U.S. Application Data
(63) Continuation of application No. 16/577,285, filed on Sep. 20, 2019.

(51) Int. Cl. H04N 1/00

(52) U.S. Cl. CPC H04N 1/00811; H04N 1/00938; H04N 2201/0094; H04N 2201/3205; H04N 1/00962

(57) ABSTRACT

According to one embodiment, an image processing apparatus includes a storage unit and a controller. The storage unit is configured to store a firmware that executes a process relating to a basic function of the image processing apparatus. The controller is configured to execute the firmware. The controller stores an application program that executes a process relating to an additional function different from the basic function in the storage unit according to a first operation received by the firmware, executes the application program according to a second operation received by the firmware, and controls a process relating to the additional function among processes to be executed by the application program according to a third operation received by the firmware.

### CROSS-REFERENCE TO RELATED APPLICATION

This application is a continuation of U.S. application Ser. No. 16/577,285 filed Sep. 20, 2019, the entire contents of which are incorporated herein by reference.

### FIELD

Embodiments described herein relate generally to an image processing apparatus, a control method, and a non-transitory recording medium.

### BACKGROUND

In the related art, an image processing apparatus that can execute an application program different from a firmware executing a process relating to a basic function of an image processing apparatus is known. Such an application program executes a process relating to a function additional to the basic function of the image processing apparatus. Thus, as functions of the image processing apparatus, not only the basic function but also the additional function is added to the image processing apparatus. As a result, a user can use the additional function in the image processing apparatus. Here, the image processing apparatus can control the basic function using the additional function. However, the image processing apparatus cannot control the additional function using the basic function. Therefore, it may be difficult for the image processing apparatus to improve the convenience of the user when using the additional function.

### DESCRIPTION OF THE DRAWINGS

FIG. 1 is an exterior view illustrating an overall configuration example of an image processing apparatus according to an embodiment;

FIG. 2 is a diagram illustrating a functional configuration example of the image processing apparatus;

FIG. 3 is a diagram illustrating an example of a flow of a process in which a controller displays a job state display image on a display;

FIG. 4 is a diagram illustrating an example of a flow of a process in which the controller updates the job state display image;

FIG. 5 is a diagram illustrating an example of the job state display image; and

FIG. 6 is a diagram illustrating an example of a flow of a process that is executed by the controller according to an operation received from the job state display image.

### DETAILED DESCRIPTION

In general, according to one embodiment, an image processing apparatus includes a storage unit and a controller. The storage device is configured to store a firmware that executes a first process relating to a basic function of the image processing apparatus. The controller is configured to execute the firmware. The controller is configured to store an application program, that executes a second process relating to a function additional to the basic function, in the storage device according to a first operation received by the firmware, execute the application program according to a second operation received by the firmware, and control the second process relating to the additional function among processes to be executed by the application program according to a third operation received by the firmware.

Hereinafter, an image processing apparatus according to an embodiment will be described. In the respective drawings, the same components will be represented by the same reference numerals. Hereinafter, an image processing apparatus 100 will be described as an example of the image processing apparatus according to the embodiment.

Details of Image Processing Apparatus

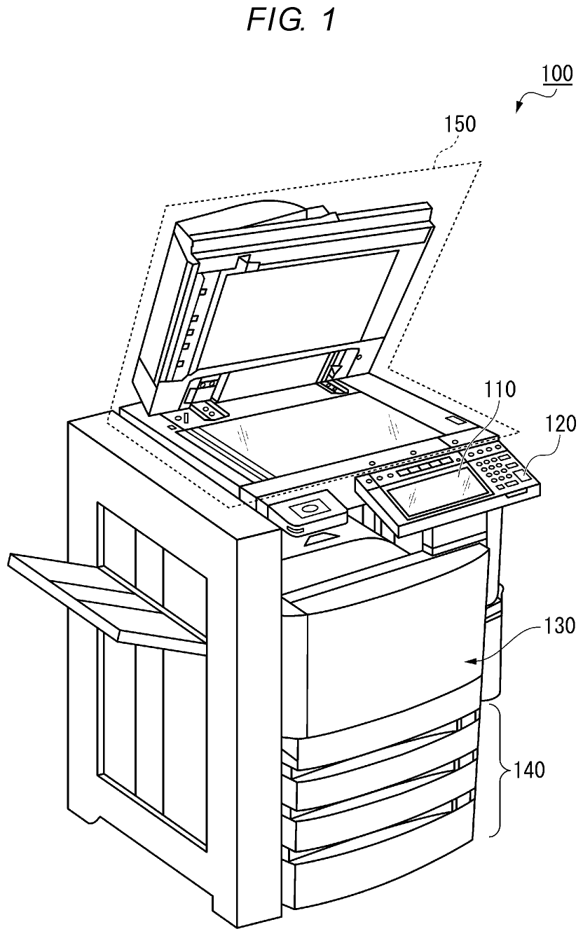

Hereinafter, the image processing apparatus 100 will be described in detail with reference to FIG. 1.

FIG. 1 is an exterior view illustrating an overall configuration example of an image processing apparatus 100 according to the embodiment. The image processing apparatus 100 is an apparatus that executes image processing, for example, a multi-function peripheral, a scanner, or a Facsimile (FAX). The image processing refers to a process relating to an image. Examples of the image processing include a process of forming an image on a sheet, a process of reading image information of a reading target, a process of recording (storing) image information, and a process of transmitting an image to another apparatus.

The image processing apparatus 100 includes a display 110, a control panel 120, a printer unit 130, a sheet accommodation unit 140, and an image reading unit 150. The printer unit 130 in the image processing apparatus 100 may be a device that fixes a toner image or an ink jet device.

The image processing apparatus 100 reads an image formed on the sheet to generate digital data and generates an image file using the digital data. The sheet may be, for example, paper on which an original document, a character, an image, or the like is printed. The sheet may be any material as long as it is a material that can be read by the image processing apparatus 100.

The display 110 is an image display device such as a liquid crystal display or an organic electro luminescence (EL) display. The display 110 displays various types of information relating to the image processing apparatus 100.

The control panel 120 includes a plurality of buttons. The control panel 120 receives the operation of a user. The control panel 120 outputs a signal corresponding to the operation input by the user to a controller of the image processing apparatus 100. The display 110 and the control panel 120 may be configured to be integrated into a touch panel.

The printer unit 130 forms an image on the sheet based on image information generated by the image reading unit 150 or image information received through a communication path. The printer unit 130 forms an image through, for example, the following process. An image forming unit of the printer unit 130 forms an electrostatic latent image on a photoconductive drum based on the image information. The image forming unit of the printer unit 130 applies a developer to the electrostatic latent image to form a visible image. Specific examples of the developer include toner. A transfer unit of the printer unit 130 transfers the visible image to the sheet. The fixing unit of the printer unit 130 applies heat and pressure to the sheet to fix the visible image to the sheet. The sheet on which the image is formed may be a sheet accommodated in the sheet accommodation unit 140 or a sheet that is manually fed.

The sheet accommodation unit 140 accommodates the sheet used for forming the image in the printer unit 130.

The image reading unit 150 reads image information of a reading target as light and dark of brightness of light. The image reading unit 150 records the read image information. The recorded image information may be transmitted to another information processing apparatus through a network. Based on the recorded image information, the printer unit 130 may form an image on the sheet.

Functional Configuration of Image Processing Apparatus

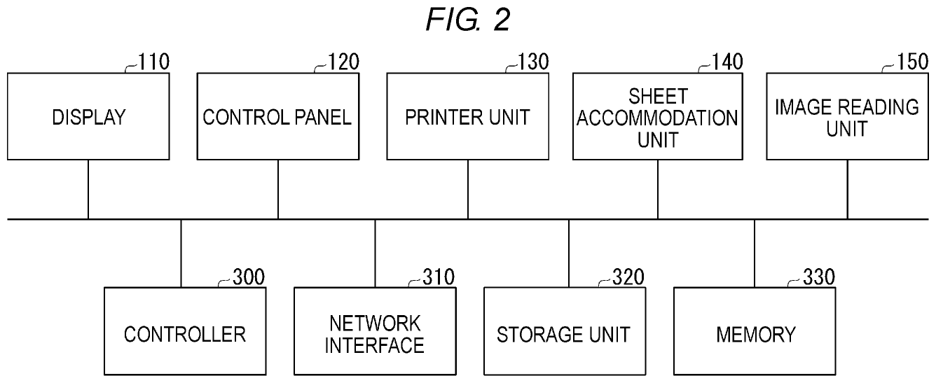

Hereinafter, a functional configuration of the image processing apparatus 100 will be described with reference to FIG. 2.

FIG. 2 is a diagram illustrating a functional configuration example of the image processing apparatus 100.

The image processing apparatus 100 includes a display 110, a control panel 120, a printer unit 130, a sheet accommodation unit 140, and an image reading unit 150. The image processing apparatus 100 includes a controller 300, a network interface 310, a storage unit (or a storage device) 320, and a memory 330. The respective functional units included in the image processing apparatus 100 are communicatively connected to each other through a system bus.

Since the details of the display 110, the control panel 120, the printer unit 130, the sheet accommodation unit 140, and the image reading unit 150 are as the same as described above, the description thereof will not be repeated. Hereinafter, the controller 300, the network interface 310, the storage unit 320, and the memory 330 will be described.

The controller 300 is an example of the controller of the image processing apparatus 100. The controller 300 includes a central processing unit (CPU) of the image processing apparatus 100. The controller 300 controls operations of the respective functional units of the image processing apparatus 100. The controller 300 executes various processes by executing programs. The controller 300 acquires an instruction input by a user from the control panel 120. That is, the controller 300 receives an operation from the user through the control panel 120. The controller 300 executes a control process based on the acquired instruction.

Here, programs executed by the controller 300 include: a firmware of the image processing apparatus 100; and one or more application programs that are installed in the image processing apparatus 100 by the user. The firmware refers to software that executes a process relating to a basic function of the image processing apparatus 100. Each of the one or more application programs refers to software that executes a process relating to an additional function different from the basic function in the image processing apparatus 100. Thus, as functions of the image processing apparatus 100, not only the basic function but also the additional function is added to the image processing apparatus 100. As a result, the user can use the additional function in the image processing apparatus 100. Each of the one or more application programs may be configured to execute not only a process relating to the additional function but also a process relating to the basic function. The firmware includes an application programming interface (API) that connects each of the application programs installed in the image processing apparatus 100 and the firmware to each other. The API is an interface through which the image processing apparatus 100 can control the basic function using the additional function. The API is an interface through which the image processing apparatus 100 can control the additional function using the basic function.

Hereinafter, for convenience of description, the firmware of the image processing apparatus 100 will be simply referred to as “firmware”. In the following description, for convenience of description, the API included in the firmware will be simply referred to as “API”. Hereinafter, a case where one application program is installed in the image processing apparatus 100 will be described as an example. In the following description, for convenience of description, the application program installed in the image processing apparatus 100 will be simply referred to as “application”. In the following description, for convenience of description, the basic function of the image processing apparatus 100 will be simply referred to as “basic function”. In the following description, for convenience of description, the process relating to the basic function will be referred to as “basic function job”. In the following description, for convenience of description, the additional function different from the basic function among the functions of the image processing apparatus 100 will be simply referred to as “additional function”. In the following description, for convenience of description, the process relating to the additional function will be referred to as “additional function job”. In the following description, for convenience of description, when it is not necessary to distinguish between the basic function job and the additional function job, the basic function job and the additional function job will be collectively referred to as “job”.

Here, the basic function refers to a function that is usable in the image processing apparatus 100 in which the application is not installed. For example, the basic function includes a function in which the image processing apparatus 100 forms an image on a sheet and a function in which the image processing apparatus 100 reads image information from an image. Examples of the basic function include a function in which the image processing apparatus 100 transmits an image by FAX and a function in which the image processing apparatus 100 receives an image by FAX.

On the other hand, the additional function refers to a function that is usable in the image processing apparatus 100 in which the application is installed. Examples of the additional function include a function of a kind of image processing that cannot be used by the user in the image processing apparatus 100 in which the application is not installed. Examples of the additional function include a function of transmitting an image to a cloud server designated by the application and a function of receiving an image from a cloud server designated by the application. The additional function may be configured to include an extended function of the basic function.

In the following description, for convenience of description, the controller 300 executing a process X1 as a process of the firmware will be referred to as “the software executing the process X1”. The process X1 may be any process as long as it is executable by the firmware. In the following description, for convenience of description, the controller 300 executing a process X2 as a process of the API in the firmware will be referred to as “the API executing the process X2”. The process X2 may be any process as long as it is executable by the API. In the following description, for convenience of description, the controller 300 executing a process X3 as a process of the application will be referred to as “the application executing the process X3”. The process X3 may be any process as long as it is executable by the application.

When the application notifies (outputs) any information to the firmware, the application notifies the information to the firmware through the API. When the application acquires any information from the firmware, the application acquires the information from the firmware through the API.

When the user installs an application in the image processing apparatus 100, the controller 300 stores the application in the storage unit 320 according to an operation received from the user. At this time, the controller 300 executes, for example, a process of setting an environmental variable to cause the application stored in the storage unit 320 to be executable, and completes the installation of the application into the image processing apparatus 100. Here, the operation is an example of the first operation.

After the application is stored in the storage unit 320, the controller 300 executes the application according to an operation received from the user. Here, the operation is an example of the second operation.

Here, another image processing apparatus different from the image processing apparatus 100 can control the basic function using the additional function. However, the image processing apparatus cannot control the additional function using the basic function. Therefore, it may be difficult for the image processing apparatus to improve the convenience of the user when using the additional function.

Therefore, the controller 300 controls the additional function job among processes to be executed by the application through the API according to an operation received from the firmware. As a result, in the image processing apparatus 100, the firmware can control the application. In other words, the image processing apparatus 100 can control the additional function using the basic function. For example, the image processing apparatus 100 can display or change a state of the additional function job using the basic function. As a result, the image processing apparatus 100 can improve convenience when using the additional function.

The additional function job is controlled by the firmware. Therefore, the application notifies information representing a state of each of one or more additional function jobs executed by the application to the firmware through the API. The application notifies the information to the firmware every time the state of any of the one or more additional function jobs executed by the application changes.

For example, when the application starts executing an additional function job, the application notifies information representing the start of the additional function job to the firmware as information representing the state of the additional function job. The application executes the notification through the API. Using this notification, the firmware can output information for identifying the additional function job to the application, for example, through the API. As a result, using this information, the firmware can manage the additional function job that is being executed by the application. For example, when the application ends the additional function job, the application notifies information representing the end of the additional function job to the firmware as information representing the state of the additional function job. The application executes the notification through the API.

The network interface 310 transmits and receives data to and from another apparatus. The network interface 310 operates as an input interface and receives data to be transmitted from the other apparatus. The network interface 310 operates as an output interface and transmits data to the other apparatus.

The storage unit 320 is, for example, an auxiliary storage device such as a hard disk, or a solid state drive (SSD). The storage unit 320 stores various kinds of information. For example, the storage unit 320 stores a program to be executed by the controller 300. The program is, for example, the firmware or the application.

The memory 330 is, for example, a random access memory (RAM). The memory 330 temporarily stores information used in each of the functional units included in the image processing apparatus 100. The memory 330 may store image information read by the image reading unit 150, a program that operates each of the functional units, and the like.

Process in which Controller Displays Job State Display Image on Display

For example, the image processing apparatus 100 displays a job state display image on the display as one basic function. The job state display image is an image that displays job information representing a job being executed by the image processing apparatus 100. As a result, the image processing apparatus 100 can notify the job information representing the job being executed by the image processing apparatus 100 to the user.

Here, job information, representing a job, can include at least information representing a state of the job. In the following description, for example, the job information representing the job includes not only the information representing the state of the job but also each of a job ID of the job, a job type, a job start time, the number of processed pages, and an application ID.

In the embodiment, the state of the job in the image processing apparatus 100 is classified into, for example, any one of four states including “Running”, “Stopped”, “Normal End”, and “Abnormal End”. The state of the job in the image processing apparatus 100 may be classified into three or less states or may be classified into five or more states. The types of states into which the state of the job in the image processing apparatus 100 is classified may include other types instead of a part or all of “Running”, “Stopped”, “Normal End”, and “Abnormal End”.

The job ID of a job refers to information for identifying the job. The job type of the job refers to information representing a type of the job. The job start time refers to information representing the time when the execution of the job is started. The number of processed pages included in the job information representing the job refers to information representing the number of pages of which the job is already executed in image information as a target on which the job is to be executed. The application ID included in the job information representing the job refers to information for identifying the application that is executing the job. When the job is a job that is executed by the firmware, the application ID may be information representing the firmware, may be null information, or may be another piece of information.

In another image processing apparatus different from the image processing apparatus 100, the job state display image displays only job information representing the basic function job. On the other hand, in the image processing apparatus 100, as described above, the firmware controls the application through the API. Therefore, in the image processing apparatus 100, the job state display image can display not only the job information representing the basic function job but also job information representing the additional function job.

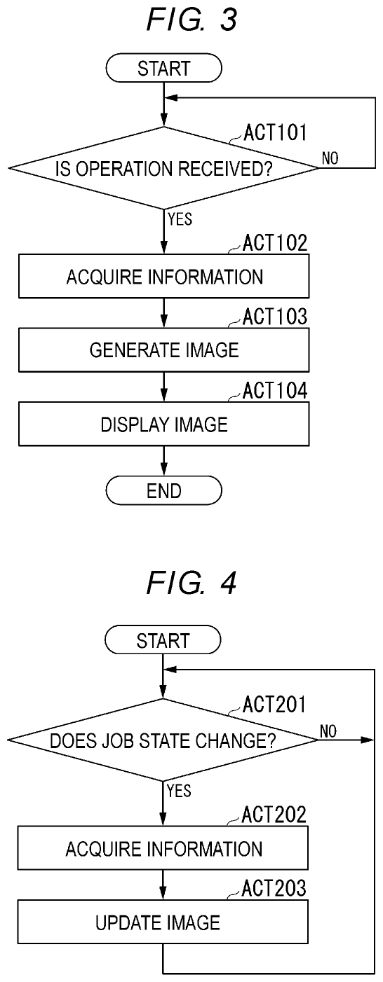

Hereinafter, a process in which the controller 300 displays the job state display image on the display 110 will be described with reference to FIG. 3. The job state display image may be an image displaying not only job information representing a job that is executed but also job information representing a job that is not executed. The job state display image is an image that displays the job information representing the additional function job without displaying the job information representing the basic function job. The job state display image is an example of the process state display image.

FIG. 3 is a diagram illustrating an example of the flow of a process in which the controller 300 displays the job state display image on the display 110.

The firmware waits until an operation of displaying the job state display image is received through the control panel 120 (ACT 101). The operation of displaying the job state display image is an example of the third operation and is also an example of the fourth operation.

When the firmware determines that the operation of displaying the job state display image is received (ACT 101—YES), the firmware acquires the job information representing the additional function job that is being executed by the application from the application (ACT 102). Here, in ACT 102, the firmware acquires the job information from the application through the API. In ACT 102, when a plurality of additional function jobs is being executed by the application, the firmware acquires job information representing each of the additional function jobs from the application. In ACT 102, the firmware generates job information representing the basic function job that is being executed by the firmware. In ACT 102, when a plurality of basic function jobs is being executed by the firmware, the firmware generates job information representing each of the basic function jobs.

Next, the firmware generates the job state display image (ACT 103). Specifically, the firmware generates the process state display image based on the job information representing the basic function job and the job information representing the additional function job. The job information representing the basic function job refers to the job information representing the basic function job generated in ACT 102. The job information representing the additional function job refers to the job information representing the additional function job acquired from the application in ACT 102.

Next, the firmware displays the process state display image generated in ACT 103 on the display 110 (ACT 104), and ends the process.

This way, the image processing apparatus 100 displays the job state display image on the display 110 according to an operation received by the firmware, the job state display image displaying the job information representing the job that is being executed by the image processing apparatus 100. As a result, the image processing apparatus 100 can notify the job information representing the additional function job that is being executed by the application to the user through the job state display image. In other words, in the image processing apparatus 100, the user can check the job information representing the additional function job that is being executed by the application without displaying the image generated by the application on the display 110. This leads to a reduction in the time and effort of the user when the user checks the job information. As a result, the image processing apparatus 100 can improve the convenience of the user when using the additional function.

Here, the controller 300 updates the job state display image displayed on the display 110 every time the state of at least one job among the jobs that are being executed by the image processing apparatus 100 changes. Hereinafter, a process in which the controller 300 updates the job state display image will be described with reference to FIG. 4. The controller 300 may be configured not to update the job state display image even when the state changes. In this case, the controller 300 updates the job state display image according to an operation received from the user.

FIG. 4 is a diagram illustrating an example of the flow of the process in which the controller 300 updates the job state display image. As an example, FIG. 4 illustrates a case where the job state display image is already displayed on the display 110 at a timing before executing the process of ACT 201 in FIG. 4.

The firmware waits until the state of at least one job among the jobs that are being executed changes (ACT 201). Here, when the state of the additional function job that is being executed changes, the application outputs information to the firmware as information for notifying the change of the state to the firmware through the API. The information is job information representing the additional function job of which the state changes. In ACT 201, when the job information is acquired from the application as described above, the firmware determines that the state of the additional function job that is being executed changes. On the other hand, in ACT 201, as long as the job information is not acquired from the application, the firmware determines that the state of the additional function job that is being executed does not change. In ACT 201, the firmware may determine whether or not the state of the basic function job that is being executed changes using any method.

When the firmware determines that the state of at least one job among the jobs that are being executed changes (ACT 201—YES), the firmware proceeds to ACT 202. The firmware acquires the job information representing the additional function job that is being executed by the application from the application through the API (ACT 202). Here, in ACT 202, the firmware acquires the job information from the application through the API. In ACT 202, when a plurality of additional function jobs is being executed by the application, the firmware acquires job information representing each of the additional function jobs from the application. In ACT 202, the firmware generates job information representing the basic function job that is being executed by the firmware. In ACT 202, when a plurality of basic function jobs is being executed by the firmware, the firmware generates job information representing each of the basic function jobs.

Next, the firmware updates the process state display image (ACT 203). Specifically, the firmware generates the process state display image based on the job information representing the basic function job and the job information representing the additional function job. The job information representing the basic function job refers to the job information representing the basic function job generated in ACT 202. The job information representing the additional function job refers to the job information representing the additional function job acquired from the application in ACT 202. The firmware displays the generated job state display image on the display 110 instead of the job state display image that is currently being displayed on the display 110. That is, the firmware updates the job state display image displayed on the display 110 in ACT 203.

After executing the process of ACT 203, the firmware proceeds to ACT 201 and waits again until the state of at least one job among the jobs that are being executed changes.

This way, the image processing apparatus 100 updates the job state display image displayed on the display 110 every time the state of at least one job among the jobs that are being executed changes. As a result, when the state changes, the image processing apparatus 100 can rapidly notify the change of the state to the user through the job state display image.

Job State Display Image

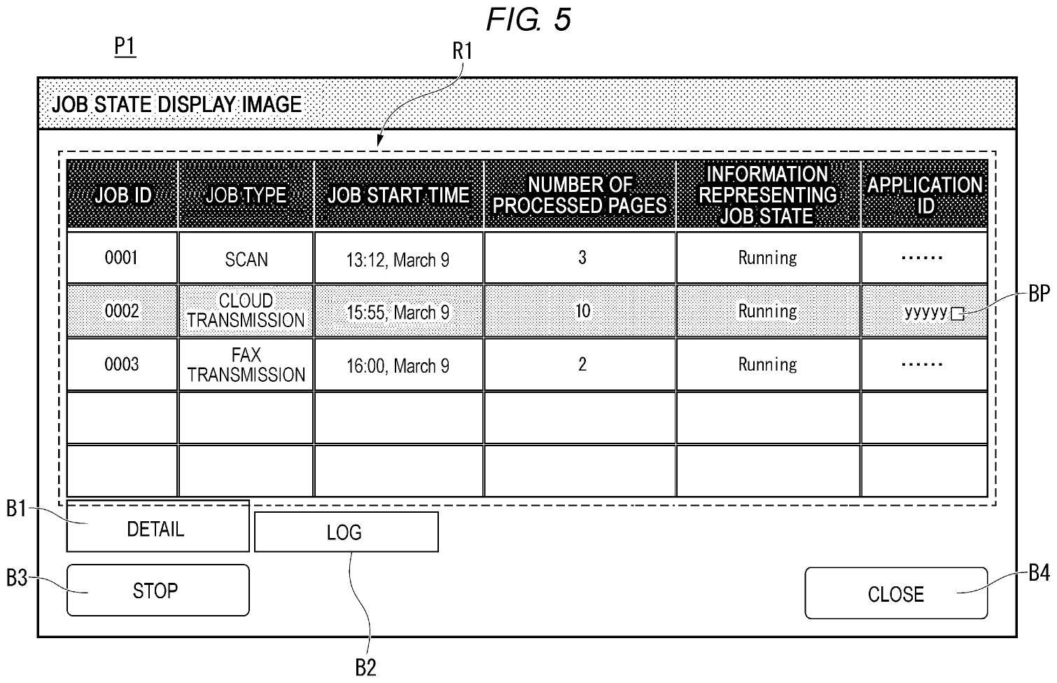

Hereinafter, the job state display image will be described with reference to FIG. 5. FIG. 5 is a diagram illustrating an example of the job state display image.

An image P1 illustrated in FIG. 5 is an example of the job state display image. The image P1 includes a region R1 and five buttons including a button B1, a button B2, a button B3, a button B4, and a button BP.

The region R1 refers to a region where job information representing a job that is being executed is displayed. Here, in the example illustrated in FIG. 5, the region R1 displays job information representing each of two basic function jobs and job information representing one additional function job. Job information having a job ID of “0001” is an example of job information representing one of the two basic function jobs. Job information having a job ID of “0003” is an example of job information representing another one of the two basic function jobs. On the other hand, job information having a job ID of “0002” is an example of the job information representing the additional function job.

In the example illustrated in FIG. 5, the basic function job that is identified by the job ID of “0001” is a process in which the image reading unit 150 reads image information from an image. Therefore, in FIG. 5, in a record including the job ID, a character string “Scan” is displayed as an example of the job type. In the example, the basic function job starts at 13:12, March 9. Therefore, in FIG. 5, in a record including the job ID, a character string “13:12, March 9” is displayed as an example of the job start time. In the example, three pages from page 1 to page 3 in image information of a target on which the basic function job is to be executed are already processed. Therefore, in FIG. 5, in a record including the job ID, a character “3” is displayed as an example of the number of processed pages. In the example, the state of the basic function job is classified into “Running”. Therefore, in FIG. 5, in a record including the job ID, a character string “Running” is displayed as an example of the information representing the state of the job. In the example, the state of the basic function job is a state where the basic function job is being executed by the firmware. Therefore, in FIG. 5, in a record including the job ID, a character string “______” is displayed as an example of the application ID.

In the example illustrated in FIG. 5, the additional function job that is identified by the job ID of “0002” is a process in which the application transmits an image to a cloud server designated by the application. Therefore, in FIG. 5, in a record including the job ID, a character string “Cloud Transmission” is displayed as an example of the job type. In the example, the additional function job starts at 15:55, March 9. Therefore, in FIG. 5, in a record including the job ID, a character string “15:55, March 9” is displayed as an example of the job start time. In the example, ten pages from page 1 to page 10 in image information of a target on which the additional function job is to be executed are already processed. Therefore, in FIG. 5, in a record including the job ID, a character “10” is displayed as an example of the number of processed pages. In the example, the state of the additional function job is classified into “Running”. Therefore, in FIG. 5, in a record including the job ID, a character string “Running” is displayed as an example of the information representing the state of the job. In the example, the state of the additional function job is a state where the additional function job is being executed by one application. Therefore, in FIG. 5, in a record including the job ID, a character string “yyyyy” for identifying the application is displayed as an example of the application ID.

In the example illustrated in FIG. 5, the basic function job that is identified by the job ID of “0003” is a process of transmitting an image by FAX. Therefore, in FIG. 5, in a record including the job ID, a character string “Fax Transmission” is displayed as an example of the job type. In the example, the basic function job starts at 16:00, March 9. Therefore, in FIG. 5, in a record including the job ID, a character string “16:00, March 9” is displayed as an example of the job start time. In the example, two pages from page 1 to page 2 in image information of a target on which the basic function job is to be executed are already processed. Therefore, in FIG. 5, in a record including the job ID, a character “2” is displayed as an example of the number of processed pages. In the example, the state of the basic function job is classified into “Running”. Therefore, in FIG. 5, in a record including the job ID, a character string “Running” is displayed as an example of the information representing the state of the job. In the example, the state of the basic function job is a state where the basic function job is being executed by the firmware. Therefore, in FIG. 5, in a record including the job ID, a character string “______” is displayed as an example of the application ID.

This way, in the region R1 of the job state display image, the job information representing each of the jobs that are being executed by the image processing apparatus 100 is displayed. As a result, the image processing apparatus 100 can notify the job information representing the additional function job that is being executed by the image processing apparatus 100 to the user through the job state display image. In other words, the user can check not only the job information representing the basic function job but also the job information representing the additional function job through the job state display image without executing an operation on the application. This leads to a reduction in the time and effort of the user when the user checks the job information representing the additional function job. As a result, the image processing apparatus 100 can improve the convenience of the user when using the additional function.

In the example illustrated in FIG. 5, in the region R1, the job information is displayed in ascending order of the job start time. However, instead of being displayed in ascending order of the job start time, the job information displayed in the region R1 may be displayed based on another rule or may be freely displayed.

In the region R1, a graphical user interface (GUI) on which an operation reception image is displayed is displayed at a position associated with each of the job information representing the displayed additional function jobs. In the example illustrated in FIG. 5, in a record including the additional function job that is identified by the job ID of “0002”, the GUI is displayed as a button BP in a field where the application ID is displayed. The GUI is an example of the second GUI.

The operation reception image refers to an image through which an operation for the application is received among images to be generated by the application. For example, when an operation (for example, clicking or tapping) for the button BP is received, the firmware causes the application to generate the operation reception image of the application through the API. Here, the application refers to the application that is identified by the application ID in the field where the button BP is displayed. The firmware causes the application to display the operation reception image generated by the application on the display 110 through the API. As a result, in the image processing apparatus 100, the user can cause the operation reception image of a desired application to be displayed on the display 110 through the job state display image In other words, the user can check not only the job information representing the basic function job but also the job information representing the additional function job through the job state display image without executing an operation on the application. This leads to a reduction in the time and effort of the user when the user checks the job information representing the additional function job. As a result, the image processing apparatus 100 can improve the convenience of the user when using the additional function. For example, when an operation for the button BP is received, the firmware may cause the application to generate an image different from the operation reception image of the application through the API. The image may be any image as long as it is an image generated by the application.

In the region R1, the firmware receives an operation in which the user selects desired job information among the displayed respective job information from the user. The firmware changes the display manner of a record including the job information selected according to the received operation to a display manner different from display manners of other records. For example, the firmware changes the background color of the record including the job information selected according to the received operation to a background color different from background colors of other records. In the example illustrated in FIG. 5, in the region R1, the background color of a record including the additional function job that is identified by the job ID of “0002” is different from background colors of other records. That is, this shows that, in the region R1, the firmware receives the operation of selecting the additional function job from the user.

The button B1 is a button for displaying an image on the display 110, the image displaying more detailed information representing the state of the job of the job information selected in the region R1. Examples of the information include estimated time when the job ends, information relating to image information on which the job is executed, and a progress state of the job. However the information is not limited to these examples. When an operation (for example, clicking or tapping) for the button B1 is received, the firmware generates the image. At this time, the firmware optionally acquires various types of information from the application through the API. After forming the image, the firmware displays the generated image on the display 110. The job state display image may be configured not to include the button B1.

The button B2 is a button for displaying an image on the display 110, the image displaying a log representing the job of the job information selected in the region R1. When an operation (for example, clicking or tapping) for the button B2 is received, the firmware generates the image. At this time, the firmware optionally acquires various types of information from the application through the API. After forming the image, the firmware displays the generated image on the display 110. The job state display image may be configured not to include the button B2.

The button B3 is a button for stopping the job of the job information selected in the region R1. When an operation (for example, clicking or tapping) for the button B3 is received, the firmware stops the job. At this time, the firmware optionally outputs various requests to the application through the API. For example, when the job is the additional function job, the firmware outputs a request of stopping the additional function job to the application through the API. As a result, the firmware can cause the application to stop the additional function job. The button B3 is an example of the first GUI. The operation for the button B3 is an example of the third operation. The job state display image may be configured not to include the button B3.

The button B4 is a button for deleting the display of the process state display image on the display 110. When an operation (for example, clicking or tapping) for the button B4 is received, the firmware deletes the image. The job state display image may be configured not to include the button B4.

This way, by displaying the job state display image on the display 110, the image processing apparatus 100 can receive an operation of changing the state of the additional function job that is being executed through the job state display image. As a result, the image processing apparatus 100 can improve the convenience of the user when using the additional function.

The image processing apparatus 100 may be configured to change the state of the additional function job that is being executed, for example, according to an operation received through the control panel 120 without passing through the job state display image.

The job state display image may be configured to include a GUI through which the execution of an additional function job that is not being executed among additional function jobs to be executed by the application is started. As a result, the image processing apparatus 100 can cause the user to execute an additional function job that is desired by the user among additional function jobs to be executed by the application through the job state display image.

Process that is executed by Controller according to Operation received from Job State Display Image

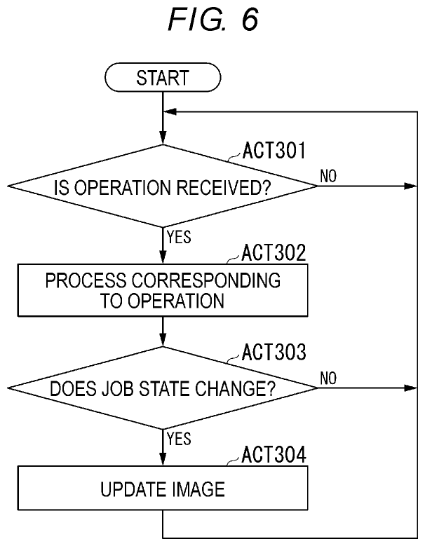

Hereinafter, a process that is executed by the controller 300 according to an operation received from the job state display image will be described with reference to FIG. 6. FIG. 6 is a diagram illustrating an example of the flow of the process that is executed by the controller 300 according to the operation received from the job state display image.

Hereinafter, for example, a case where the job state display image is the image P1 illustrated in FIG. 5 will be described.

The firmware waits until an operation is received through the job state display image (ACT 301).

When the firmware determines that an operation is received through the job state display image (ACT 301—YES), the firmware executes a process corresponding to the operation (ACT 302).

For example, when the operation received through the job state display image is an operation of selecting one of the job information displayed in the region R1, the firmware changes the display manner of a record including the job information selected by the operation to a predetermined display manner. The predetermined display manner is the display manner different from display manners of other records than the record. The firmware specifies the job information selected by the operation as the job information that is desired by the user.

For example, when the operation received through the job state display image is an operation for the button BP, the firmware causes the application to generate the operation reception image through the API. Here, the application refers to the application that is identified by the application ID in the field where the button BP is displayed. The firmware causes the application to display the operation reception image generated by the application on the display 110 through the API.

For example, when the operation received through the job state display image is an operation for the button B1, the firmware executes a detailed information display process. The detailed information display process is a process of displaying an image on the display 110, the image displaying more detailed information representing the state of the job of the job information selected in the region R1. At this time, when the job information is job information representing the additional function job, the firmware acquires the more detailed information representing the state of the job information from the application through the API. The firmware generates the image based on the information. The firmware displays the generated image on the display 110.

For example, when the operation received through the job state display image is an operation for the button B2, the firmware executes a log display process. The log display process is a process of displaying an image on the display 110, the image displaying a log representing the job of the job information selected in the region R1. At this time, when the job information is job information representing the additional function job, the firmware acquires the log representing the job from the application through the API. The firmware generates the image based on the log. The firmware displays the generated image on the display 110.

For example, when the operation received through the job state display image is an operation for the button B3, the firmware executes a stop process. The stop process is a process of stopping the job of the job information selected in the region R1. At this time, when the job information is job information representing the additional function job, the firmware stops the additional function job through the API.

For example, when the operation received through the job state display image is an operation for the button B4, the firmware deletes the display of the job state display image on the display 110.

After executing the process of ACT 302, the firmware determines whether or not the state of at least one job among the jobs that are being executed is changed by the process in ACT 302 (ACT 303).

When the firmware determines that the state of at least one job among the jobs that are being executed is not changed by the process in ACT 302 (ACT 303—NO), the firmware proceeds again to ACT 301. The firmware waits again until an operation is received through the job state display image.

On the other hand, when the firmware determines that the state of at least one job among the jobs that are being executed is changed by the process in ACT 302 (ACT 303—YES), the firmware proceeds to ACT 304. The firmware updates the job state display image (ACT 304). Here, since the process of ACT 304 is the same as the process of ACT 203 in FIG. 4, the description thereof will not be repeated.

After executing the process of ACT 304, the firmware proceeds to ACT 301 and waits again until an operation is received through the job state display image.

This way, the controller 300 executes a process corresponding to the operation received from the job state display image. The process that is executed by the controller 300 according to the operation received from the job state display image includes a process of changing the state of the additional function job. That is, the controller 300 can change the state of the additional function job according to the operation received from the job state display image. In other words, the controller 300 can control the additional function job that is executed by the application according to the operation that is received by the firmware through the job state display image. As a result, the image processing apparatus 100 can improve the convenience of the user when using the additional function.

The application described above may be an application program that is stored in an external storage device and can be executed without being installed into the image processing apparatus 100. In this case, the firmware includes an API that connects the firmware and the application program to each other. In this case, the firmware controls a process that is executed by the application program through the API.

As described above, the image processing apparatus (in this example, the image processing apparatus 100) includes a storage unit and a controller. The storage unit is configured to store a firmware that executes a process (in the example described above, the basic function job) relating to a basic function of the image processing apparatus. The controller is configured to execute the firmware. The controller stores an application program that executes a process (in the example described above, the additional function job) relating to an additional function different from the basic function in the storage unit according to a first operation received by the firmware, executes the application program according to a second operation received by the firmware, and controls a process relating to the additional function among processes to be executed by the application program according to a third operation received by the firmware. As a result, the image processing apparatus can improve the convenience of the user when using the additional function.

A program for implementing a function of any component in the apparatus (for example, the image processing apparatus 100) described above may be executed by recording the program in a computer-readable recording medium and reading the program to a computer system. The definition of “computer system” described herein includes an operating system (OS) and hardware such as a peripheral device. The “computer-readable recording medium” refers to a storage device, for example, a portable medium such as a flexible disk, a magneto-optic disk, a ROM, or a compact disk (CD)-ROM or a hard disk built into a computer system. The “computer-readable recording medium” may also refer to a medium that stores a program for a certain period of time, for example, a volatile memory (RAM) in a computer system that functions as a server or a client when the program is transmitted through a network such as the Internet or a communication line such as a telephone line.

The program may be transmitted from a computer system that includes a storage device or the like storing the program to another computer system through a transmission medium or through a transmission wave in a transmission medium. Here, “transmission medium” that transmits the program refers to a medium having a function of transmitting information, for example, a network (communication network) such as the Internet or a communication line (communication line) such as a telephone line.

The program may implement some of the above-described functions. The program may be a so-called difference file (difference program) that can implement the above-described function in combination with a program that is recorded in advance in a computer system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a storage device configured to store a firmware that executes a first process relating to a basic function of the image processing apparatus;
a controller configured to:
execute the firmware;
store an application program, that executes a second process relating to an additional function, in the storage unit according to a first operation received by the firmware, wherein the firmware includes an application programming interface that connects the application programs and the firmware to each other;
execute the application program according to a second operation received by the firmware; and
control the second process relating to the additional function among processes to be executed by the application program through the application programming interface according to a third operation received by the firmware, wherein the application program notifies information representing a state of the second process relating to an additional function to the firmware through the application programming interface; and
a display unit, wherein
the controller is further configured to:
generate a process state display image that displays (i) information representing a state of the first process relating to the basic function executed by the firmware; and (ii) information representing a state of the second process relating to the additional function executed by the application program acquired through the application programming interface; and
display the generated process state display image on the display unit according to a fourth operation received by the firmware.

2. The apparatus according to claim 1, wherein
the process state display image includes a first graphical user interface (GUI) through which the third operation is received, and
the controller is further configured to:
receive the third operation through the first GUI included in the process state display image; and
stop the second process related to the additional function through the application programming interface according to the third operation received.

3. The apparatus according to claim 1, wherein
when the state of the second process relating to the additional function changes, the controller is further configured to update the process state display image displayed on the display unit.

4. The apparatus according to claim 1, wherein
the process state display image includes a second GUI through which an operation reception image generated by the application program is displayed on the display unit, the operation reception image configured to receive an operation for the application program, and
when an operation is received through the second GUI of the process state display image, the controller is further configured to:
control the application program through the application programming interface so that the application program generates the operation reception image; and
display the operation reception image acquired through the application programming interface on the display unit.

5. The apparatus according to claim 1, wherein
the controller is further configured to change a state of a third process selected by the third operation among the processes to be executed by the application program according to the third operation.

6. The apparatus according to claim 5, wherein
the controller is further configured to stop the third process selected by the third operation among the processes to be executed by the application program according to the third operation.

7. The apparatus according to claim 5, wherein
the controller is further configured to start the third process selected by the third operation among the processes to be executed by the application program according to the third operation.

8. The apparatus according to claim 1, wherein the additional function includes at least one of a transmitting function to or a receiving function from a cloud server designated by the application program.

9. A control method of the image processing apparatus including a storage device configured to store a firmware that executes a first process relating to a basic function of the image processing apparatus and a controller configured to execute the firmware, the method comprising:
storing an application program, that executes a second process relating to an additional function, in the storage device according to a first operation received by the firmware, wherein the firmware includes an application programming interface that connects the application programs and the firmware to each other;
executing the application program according to a second operation received by the firmware;
controlling the second process relating to the additional function among processes to be executed by the application program through the application programming interface according to a third operation received by the firmware, wherein the application program notifies information representing a state of the second process relating to an additional function to the firmware through the application programming interface;
generating a process state display image that displays (i) information representing a state of the first process relating to the basic function executed by the firmware; and (ii) information representing a state of the second process relating to the additional function executed by the application program acquired through the application programming interface; and
displaying the generated process state display image on the display unit according to a fourth operation received by the firmware.

10. The method of claim 9, wherein the additional function includes at least one of a transmitting function to or a receiving function from a cloud server designated by the application program.

11. The method of claim 9, further comprising:
receiving the third operation through a first graphical user interface (GUI) included in the process state display image; and
stopping the second process related to the additional function through the application programming interface according to the third operation received.

12. The method of claim 9, wherein when the state of the second process relating to the additional function being executed by the application program changes, the method further comprising:
updating the process state display image displayed on the display unit.

13. The method of claim 9, further comprising:
changing a state of a third process selected by the third operation among the processes to be executed by the application program according to the third operation.

14. The method of claim 13, further comprising:
stopping the third process selected by the third operation among the processes to be executed by the application program according to the third operation.

15. The method of claim 9, further comprising:
starting the third process selected by the third operation among the processes to be executed by the application program according to the third operation.

16. A non-transitory recording medium storing a program for allowing a computer of an image processing apparatus including a storage unit configured to store a firmware that executes a first process relating to a basic function of the image processing apparatus and a controller configured to execute the firmware, the program allowing the computer to:
store an application program, that executes a second process relating to an additional function, in the storage unit according to a first operation received by the firmware, wherein the firmware includes an application programming interface that connects the application programs and the firmware to each other;
execute the application program according to a second operation received by the firmware;
control the second process relating to the additional function among processes to be executed by the application program through the application programming interface according to a third operation received by the firmware, wherein the application program notifies information representing a state of the second process relating to an additional function to the firmware through the application programming interface;
generate a process state display image that displays (i) information representing a state of the first process relating to the basic function executed by the firmware; and (ii) information representing a state of the second process relating to the additional function executed by the application program acquired through the application programming interface; and
display the generated process state display image on the display unit according to a fourth operation received by the firmware.
